(19) United States
(12) Patent Application Publication
(10) Pub. No.: US 2012/0134144 A1
(43) Pub. Date: May 31, 2012

(54) Device for interior lighting perfected

(76) Inventor: Pietro Grassia, Gines-Seville (ES)

(21) Appl. No.: 13/280,264

(22) Filed: Oct. 24, 2011

(30) Foreign Application Priority Data
Nov. 25, 2010 (ES) 201031183

(51) Int. Cl. F21L 4/02; F21V 21/14

(52) U.S. Cl. 362/184; 362/249.03

(57) ABSTRACT

Device for interior lighting perfected composed of a set of compact Led lights with built-in electronics that is dirigible, adjustable, arranged in a small-sized support and supply rail and adapted to Led technology, which covers all the possibilities regarding the application and use of accessories of traditional lighting systems, and it is applied for the first time to Led lighting, thus producing the first multiple supply Led rail with variable light position. The system is composed of a dirigible and adjustable compact light including a Led with electronics built into the light's mast and a support and supply rail adapted to the aforementioned light.

### PURPOSE OF THE INVENTION

This invention, as expressed in the statement of this descriptive report, is a device or lighting system composed of a set of compact Led lights with built-in electronics that is dirigible, adjustable, arranged in a small-sized support and supply rail and adapted to Led technology.

This invention has been conceived for exhibition lighting, interior design, decoration, window dressing and commercial architecture. It has also been conceived for more specific applications such as in medicine, law—forensic lighting, botany and horticulture, as well as in catastrophes and/or emergency situations thanks to its size and low consumption in relation to the light power it emits and its versatility. It can be supplied as battery or solar-powered.

### BACKGROUND OF TECHNOLOGY

Considering the state of the technology of Led lights for interiors, the current lights available in the market provide essentially spit light. Therefore, the lens is used essentially to concentrate the ray and increase its power but not its definition.

As a result, light orientation is always partial, and typical professional lighting accessories such as filter holders, different types of lenses, dousers, visors, etc. cannot be installed. Therefore, operating them is complicated and rigid, as it does not adapt to continued variations in use.

Research in Led lighting currently concentrates on increasing Led power. This system includes cluster lighting technology, which enables distributing many low power rays of light in a precise manner until a homogeneous light is achieved without increasing the heat produced by a brighter Led.

Neither are there currently any supports for Led lights in the market with the versatility of a distribution rail for traditional lights.

Therefore, the “Perfected device for interior lighting” provides—with respect to the current technology in the field—a Led lighting system on rails that covers all the possibilities regarding the application and use of accessories of traditional lighting systems, and it is applied for the first time to Led lighting, thus producing the first multiple supply Led rail with variable light position.

The proposed invention consists of a device with a Led light whose Led can be replaced, or the lens, due to breakdown or change in functionality without having to change or dispose of the entire light.

A professional lighting system with high light-producing power for interiors is achieved with the additional advantages provided by Led lighting. In fact, by incorporating Led technology, the Led's automatic work temperature control and adjustment system makes it suitable for applications in which a constant level of light is required.

Lastly, the light's fixing and power supply is carried out by means of safety magnets that allow a fast and easy assembly without any tools, as so is the orientation block which is performed with a single control with a nut, thus making it most suitable for small and delicate spaces such as showcases and shop windows or environments with fragile and delicate objects.

The polarity of the magnets can be adjusted, as when connecting a Led the phase/neutral polarity is not indifferent (such as in 220 v); an incorrect installation is currently the most common cause of failure of Leds because the electronics are burnt if connected the wrong way round. The magnets comprising the proposed device attract the correct pole and repel the wrong pole. They are positioned positive/negative in conformance with the magnet's north/south. They are positioned in this way so they coincide with the exterior cover of the rail, thus avoiding polarity inversions.

### EXPLANATION OF THE INVENTION

As an explanation of the “Perfected device for interior lighting”, it is composed of a dirigible and adjustable compact light including a Led with electronics built into the light's mast and a support and supply rail adapted to the aforementioned light.

Both main elements are described as follows:

### Rail

Small-sized rail, for example 20×8 millimeters, manufactured in anodized aluminum in several colors and provided with a fixing system (horizontal and vertical positions), which can be fixed either screwed or hanged. Fixing the rail to its footing is carried out manually and easily by means of a nut.

Power supply of the rail by means of a supply piece located in any of the two ends.

24 v power supply by means of an internal PCB. Power and distribution circuit physically separated for safety reasons.

Possibility of positioning a light every three centimeters.

Possibility of different size modules, designed for 25 cm, 50 cm, and 1 m modules.

Fixing system of lights to rail coinciding with the supply of the lights by means of safety magnets inserted in the fixing side of the rail, which corresponds to the position of the electrical power distribution PCB points.

### Light

Supply and support by means of safety magnets.

Electronics built-in the mast holding the lighting head in accordance with the following elements: step-down converter, a temperature rise detection system, an automatic regulator that maintains the Led at an optimum work temperature and a manual dimmer to lessen the Led's lighting so the light can be adjusted by fastening or unfastening a screw.

The orientation elbow is designed so it can be blocked in both directions: “pan” (right-left horizontal movement) and “tilt” (up-down vertical movement) by closing a single screw control.

Full orientation in both directions.

The rear of the light's head is also a heat dissipator. The dissipation is increased while maintaining its small size as it is manufactured in copper.

The printed circuit board is designed for automatic blocking once it is lodged in the correct position inside the dissipator.

The head houses a lighting/optical body which can be replaced when broken-down or to change the light's functionality.

Possibility of installing a white Led with any color temperature (K), or a color Led.

Possibility of installing a different degree collimating lens or a plano-convex lens, and the possibility of replacing them in accordance with the client's needs by performing simple operations.

Possibility of installing several accessories to the head in order to process the ray of light. This proposal comprises a glare protection cone, color and lighting conversion filters in methacrylate, light reduction visors composed of four pieces with independent movement, optical body with adjustable ray and plano-convex lens.

### DESCRIPTION OF THE DRAWINGS

As a complement to the description and with the aim of providing further insight on the invention's characteristics, the following figures are provided as an integrating part of the description:

FIG. 1. Isometric exploded view of the “Perfected device for interior lighting”.

FIG. 2. Isometric view of the “Perfected device for interior lighting” with installed rail and light set with douser cone and version with a focusable PC lens, from left to right, respectively.

FIG. 3. Isometric view of the “Perfected device for interior lighting” with installed rail and light set comprised of an opal glass plano-convex lens with several lens openings and version with collimator and several openings, from left to right, respectively.

The following elements or parts are worth mentioning:

1. Assembly base to rigid surface.

2. Fixing screw of the rail to the base.

3. Element for fixing the electrical power supply piece to the rail.

4. Printed circuit board for 24 v power supply of rail.

5. Exterior housing of the light's support rail.

6. Exterior housing of the light's support rail.

7. Printed circuit board of the light's support rail.

8. Connection failities.

9. Light base.

10. Light mast.

11. Orientation elbow.

12. Compression screw.

13. Light arm.

14. Light head.

15. Optical and lighting element.

16. Threaded ring.

17. Douser cone.

18. Cover.

19. Support tube.

20. Adjusting and blocking screw.

21. Lens holder.

22. Lens.

23. Closing ring.

### EXAMPLE OF PREFERRED EMBODIMENT

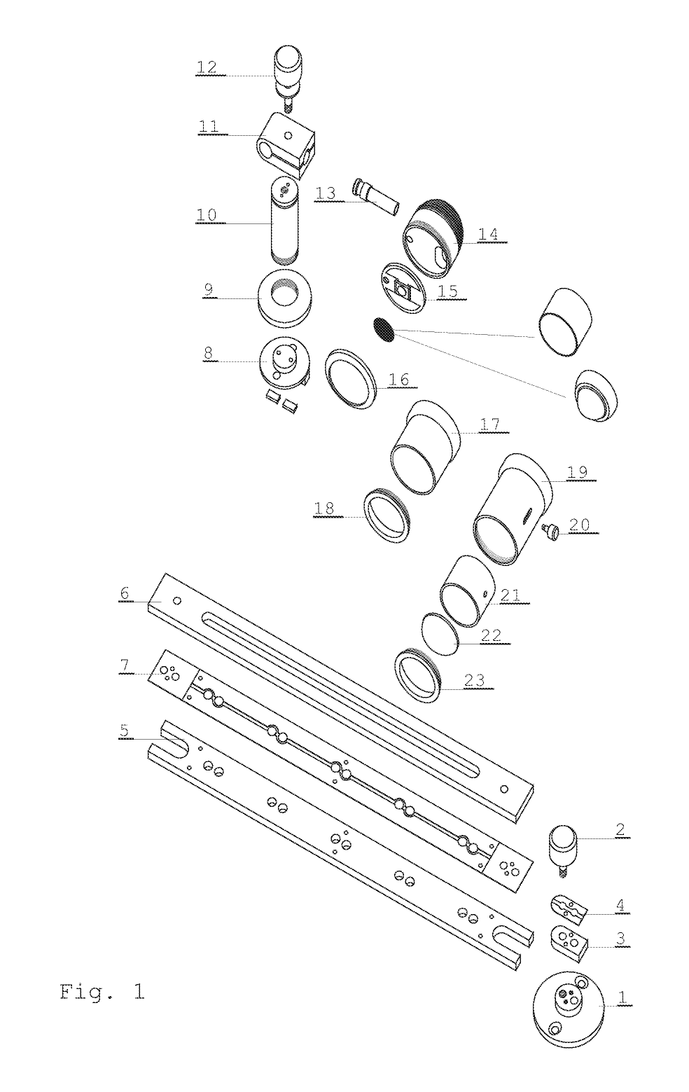

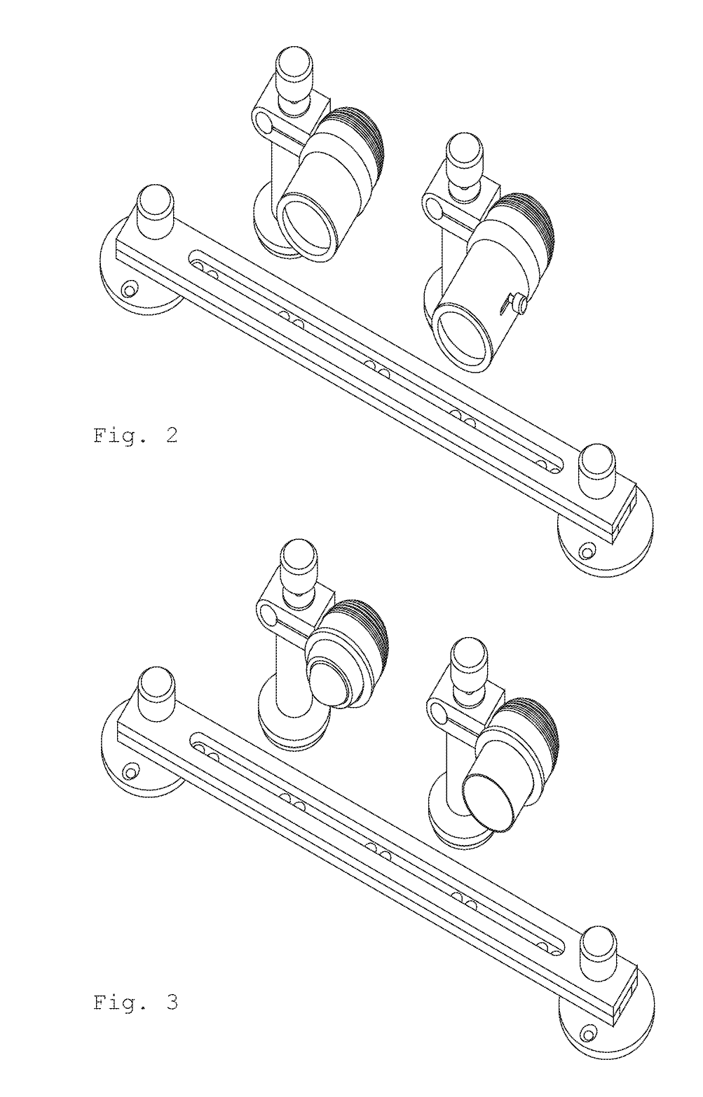

As an example of preferred embodiments of the “Perfected device for interior lighting, FIG. 1 and FIG. 2 shows how it is designed in accordance with the set comprised of the rail, lights and accessories.

With regard to the rail, it is composed of an assembly base to a rigid surface (1), which is an aluminum disc that has the following perforations or fixing elements:
a) Fixing of the base to the wall or to a horizontal or vertical surface.
b) Fixing of the rail to the base by means of an aluminum anodized nut (2).
c) Passing of the power supply cable with the option of passing through to the surface or through the base.
d) Threaded holes for fixing the electrical power supply piece to the rail (3) together with the electrical contact piece or printed circuit board (4).

The distribution rail is carried out in accordance with the exterior housing of the lights' support rail (5), interior housing (6) and printed circuit board (7). The exterior housing of the rail is carried out with an anodized aluminum bar—4 mm thick, and includes the following elements:
a) Symmetric slots at the ends for lodging the power supply piece (3 and 4).
b) Pairs of threaded holes to fix the remainder of the rail parts.
c) Pairs of safety magnets set-in and at the same level for supporting the lights.

The magnets are positioned as positive/negative so light polarity inversion is magnetically impossible.

With regard to the two-sided printed circuit board which distributes current to the rail (7), it includes the following elements on one side:
a) Through hole for the power supply cable to the rail.
b) Through hole for fixing the rail to the assembly base to surface (1).
c) Holes to fix the position of the rail's power supply piece (3) to its printed circuit board (4).
d) Electrical contacts for distributing current to the lights, in accordance with the position of the fixing magnets at the exterior surface of the rail. (5).
d) Pairs of holes between the two remaining parts of the rail for fixing.

The other side—the opposite side—lodges the electrical power supply contact to the rail (3 and 4).

Lastly, the rail includes an interior housing (6) which includes the following elements:
a) Threaded holes for fixing to the rail base by threading (2).
b) Pair of non-through threaded holes to join the remaining parts of the rail (5 and 7).
c) Position head joint for the socket of the lights' base.

With regard to the light, it is composed of a power supply socket (8) in insulating nylon with an arrangement to place it on the rail and it includes the following elements:
a) Raised shape for embedding on the head joint of the rail's housing (6).
b) Two safety magnets inserted and at the same level in the above-mentioned piece to support the lights in their position and supply them for the rail; positioned to coincide with those of the rail's exterior cover (5), thus avoiding polarity inversions.
c) Threaded holes for fixing to the base of the light (9).

The base of the light (9) is provided with a central threaded hole to embed the light's mast (10) and two non-through threaded holes to fix the power supply socket (8).

The light mast (10) is an aluminum cylinder used—as the light's base—and it can be manufactured, alternatively, using current converter electronics or simple power supply electronics, or by means of intelligent electronics consisting of a detector of the Led's work temperature and an automatic regulator to reduce the heat in the event of excessive temperature, as the Led works at an optimum temperature of 70° C.

The light's mast (10) is composed of a thread in the base so it can be fixed to the light's base (9), a top threaded hole for fixing and blocking the orientation elbow (11) and reducing the diameter to fix the orientation elbow's position (11), and, lastly, through holes for cables from the electronic components to the Led.

With regard to the orientation elbow (11), this consists of a piece shaped like a clamp in which by operating the only screw (12) the light's head position can be blocked in both directions “pan” (right-left horizontal movement) and “tilt” (up-down vertical movement). It consists of a through hole to set-in the fixing screw (12), a threaded hole to fix the light's arm (13) by means of an adapted screw, and a housing for the light's arm (13).

Compression screw (12) for the position of the light's head, which includes a clamp compression plate so it can be fixed.

Light arm (13), which has an Allen screw in the elbow that puts pressure on the slot to avoid the head from falling when oriented, while the compression screw (12) is open.

Light head (14) composed of a solid copper piece and configured the following way:
a) Dissipation laminates that increase the surface.
b) A threaded hole that allows either blocking the light's head to the arm (13) by means of a screw that protrudes one millimeter from the copper head or blocking the optical and lighting element (15) in its correct position.
c) Hole for lodging the Molex-type current connector.
d) Thread for fixing the Led and PCB (15) plus the optical body (14) by means of a threaded aluminum ring (16). 25 e) Hole for lodging the arm (13) which is blocked by means of an Allen screw located in a hole, for this purpose, of this piece; added fixing is achieved with glue.

With regard to the optical and lighting element, this is purchased in the market and it is replaced as a set. For example, a customized pcb can be used that mounts a 3 W Cree Xlamp XRE Led, fitted with a series of lenses personally chosen from two families: Ledil LC1 3°, 5°, 14° collimators or PC Ledil Twiddle 10° or 14° lenses.

Likewise, the threaded ring (16) fixes the optical and lighting body to the copper dissipating head.

Lastly, the system includes some accessories such as a douser cone (17), consisting of an aluminum cone that threads to the dissipating head by means of a thread that replaces the closing ring of the optical/lighting body (16). It is used to block the light from sight, thus avoiding glare.

Additionally, as it ends in a thread, when removing the cover (18), the douser (17) and other accessories, such as pieces from the accessory “focusable plano-convex optic lens with variable ray” can be coupled to the cone, or alternatively to the douser (17).

A more comprehensive description is not required for any expert to understand the reach of this invention and the advantages arising from its use. When implementing this technology, the design, the dimensions of the elements described and the materials used in its manufacture can be different provided that they do not alter the invention's essence.

1. Device for interior lighting perfected comprised of a set of compact dirigible and adjustable lights including a Led with electronics built-in the light pole and a support and supply rail adapted to the light described.

2. Device for interior lighting perfected in accordance with claim 1, characterized by its small sized-rail manufactured in anodized aluminum and a fixing system achieved by screwing or hanging.

3. Device for interior lighting perfected in accordance with claims 1 and 2, characterized by its rail's power supply system which is carried out by means of a supplying piece located in any of the two ends, electrical power distribution at 24 V by means of an internal PCB, and a supply and distribution circuit physically separated for safety reasons.

4. Device for interior lighting perfected in accordance with claims 1, 2 and 3, characterized by their fixing system that coincides with the supply of the lights by means of safety magnets inserted in the fixing side of the rail, which corresponds to the position of the PCB points of electrical power distribution.

5. Device for interior lighting perfected in accordance with claims 1, 2, 3 and 4, characterized by the light having a power supply system and support by means of safety magnets, as well as electronics built-in the mast holding the lighting head, in accordance with the following elements: step-down converter, a temperature rise detection system, an automatic regulator that maintains the Led at an optimum work temperature and a manual dimmer. The orientation elbow is designed so it can be blocked in both directions “pan” (right-left horizontal movement) and “tilt” (up-down vertical movement) by closing a single screw control, full orientation in both directions, the rear of the light's head is also a heat dissipator; the printed circuit board is designed for automatic blocking once it is lodged in the correct position inside the dissipator. The head houses a lighting/optical body.
